(19) United States
(12) Patent Application Publication
(10) Pub. No.: US 2026/0206802 A1
(43) Pub. Date: Jul. 23, 2026

(54) Reduced-Fat Snack Products Comprising Methylcellulose and Methods of Preparation

(71) Applicant: General Mills, Inc., Minneapolis, MN (US)

(72) Inventors: Steven Cak, Minneapolis, MN (US); Christine M. Nowakowski, Plymouth, MN (US)

(73) Assignee: General Mills, Inc., Minneapolis, MN (US)

(21) Appl. No.: 19/137,356

(22) PCT Filed: Dec. 21, 2022
(86) PCT No.: PCT/US2022/082110

§ 371 Date: Jun. 10, 2025

(51) Int. Cl. A23L 7/122; A23L 7/10; A23L 33/125; A23L 33/24

(52) U.S. Cl. CPC A23L 7/122; A23L 7/1975; A23L 33/125; A23L 33/24

(57) ABSTRACT

A method of preparing a reduced-fat fried low-moisture snack product, the method including applying a low-viscosity methylcellulose solution to a surface of a low-moisture snack food. The low-viscosity methylcellulose solution includes water, methylcellulose and a polarity-reducing agent. In preferred embodiments, the solution includes up to about 2% methylcellulose. The polarity-reducing agent can include sorbitol, erythritol and/or glycerin (glycerol). A reduced-fat fried low-moisture snack product has at least 20%, but more preferably at least about 40%, less fat than a conventional fried low-moisture snack product while maintaining desirable organoleptic characteristics of a fried food.

### BACKGROUND OF THE INVENTION

Fried snack foods, such as potato chips or French fries, are popular with consumers, providing desirable and characteristic flavors, textures, and appearances. However, fried snack foods often contain high levels of fat/oil because they typically are prepared by cooking the snack food in oil (e.g., by deep-fat frying) during which the snack food absorbs part of the oil. The uptake of fat is even more pronounced when the snack food has a low moisture content (e.g., rye chips) before frying. There is apprehensions among certain consumers regarding the health implications of consuming such high levels of fat (e.g., obesity, coronary heart disease). In attempting to achieve fried snack foods with lower levels of fat, manufacturers are particularly challenged with ensuring the fried snack foods maintain their characteristic flavors, textures, and appearances.

### SUMMARY

A method of preparing a reduced-fat fried low-moisture snack product in accordance with the present invention includes applying a low-viscosity methylcellulose solution to a surface of a low-moisture snack food to form a coated low-moisture snack food. In some embodiments, the low-moisture snack food has a moisture content from about 1% to about 10%. The method further includes frying (e.g., deep-frying) the coated low-moisture snack food.

A low-viscosity methylcellulose solution in accordance with the present invention includes water, methylcellulose and a polarity-reducing agent. In preferred embodiments, the viscosity of the solution is about 430 centipoise (cP) or less. In preferred embodiments, the solution includes up to about 2% methylcellulose (i.e., more than 0% methylcellulose but no more than about 2% methylcellulose, e.g., from about 1% to about 2%). The polarity-reducing agent functions to help lower the viscosity of the solution and prevent processability issues. In some embodiments, the low-viscosity methylcellulose solution includes from about 0.5% to about 0.75% of a polarity-reducing agent. The polarity-reducing agent can include sorbitol, erythritol and/or glycerin (glycerol).

A method of preparing a low-viscosity methylcellulose solution in accordance with the present invention includes combining water, methylcellulose and a polarity-reducing agent.

A reduced-fat fried low-moisture snack product in accordance with the present invention has at least 20%, but more preferably at least about 40% in certain forms of the invention, less fat than a conventional fried low-moisture snack product (i.e., a fried low-moisture snack product not prepared using a low-viscosity methylcellulose solution in accordance with the invention before frying). However, the reduced-fat fried low-moisture snack product maintains organoleptic characteristics of the conventional fried low-moisture snack product such as color and texture. In some embodiments, the reduced-fat fried low-moisture snack product has a fat content of from about 5% to about 20% by weight of the snack product, more preferably from about 8% to about 16%.

### BRIEF DESCRIPTION OF THE DRAWINGS

FIG. 1 is a chart showing the fat and moisture content of samples of fried rye chips either uncoated (samples 1 and 2) or coated (samples 3-14) with a low-viscosity methylcellulose solution in accordance with the present invention before being fried.

FIG. 2 is a graph showing the fat content of samples of fried rye chips either uncoated (samples 1 and 2) or coated (samples 3-14) with a low-viscosity methylcellulose solution in accordance with the present invention before being fried.

### DETAILED DESCRIPTION

Throughout the present description, unless otherwise specified, the concentrations expressed as percentages always refer to the weight/weight (w/w) percentage, i.e., grams of a given component per 100 g of composition. The term “about” refers to a deviation of plus/minus 10%, preferably plus/minus 5%. As used herein, the term “low-moisture” generally refers to a food substrate that has a moisture content of less than about 12% (e.g., from about 5% to about 10%). As used herein, the term “low-viscosity”, when referencing the methylcellulose solution, generally refers to a viscosity of about 510 centipoise (cP) or less, preferably about 430 cP or less. As used herein, the term “reduced-fat fried low-moisture snack product” or the like generally refers to a fried low-moisture snack product having at least 20% less fat than a conventionally fried low-moisture snack product (i.e., a fried low-moisture snack product not prepared in accordance with the present invention).

Examples of low-moisture snack foods include rye chips, corn chip snacks (e.g., Bugles®) and one or more components (e.g., hard pretzels, bagel chips) of snack mixes such as Chex Mix®. Compared to other snack foods that have a higher moisture content at the time of frying (e.g., raw potato slices fried to form potato chips), low-moisture snack foods absorb a greater amount of fat/oil during frying (e.g., about 20% or more, versus no more than 5% for higher moisture snack foods). A particular object of the present invention is to reduce the fat uptake in low-moisture snack foods during frying.

The inventors have discovered that applying a low-viscosity methylcellulose solution to a low-moisture snack food before the snack food is fried significantly reduces fat uptake during frying, without adversely impacting desirable organoleptic characteristics (e.g., flavors, textures, and colors). Notably, the resulting fried low-moisture snack product has no perceived gumminess or sliminess upon consumption. In some embodiments, the amount of fat absorbed (the fat uptake) is reduced by at least 20%, but more preferably at least about 40%, when compared to a fried low-moisture snack product not prepared using the low-viscosity methylcellulose solution of the present invention.

A low-viscosity methylcellulose solution in accordance with the present invention includes water, methylcellulose and a polarity-reducing agent. In preferred embodiments, the viscosity of the solution is about 430 centipoise (cP) or less. In preferred embodiments, the solution includes up to about 2% methylcellulose (i.e., more than 0% methylcellulose but no more than about 2% methylcellulose, e.g., from about 1% to about 2%).

A concentration of more than about 2% methylcellulose is not desired and results in the solution having an undesirable viscosity that inhibits its processability (e.g., too viscous to spray) and prevents an even application upon the snack food. The polarity-reducing agent functions to reduce the polarity of the solution which, in turn, reduces the hydration of the methylcellulose polymer. Reducing the hydration of the methylcellulose polymer limits its degree of gelation, helping to lower the viscosity of the solution and prevent processability issues. In some embodiments, the low-viscosity methylcellulose solution includes from about 0.5% to about 0.75% of a polarity-reducing agent. The polarity-reducing agent can include sorbitol, erythritol and/or glycerin (glycerol). In preferred embodiments, the polarity-reducing agent includes erythritol and/or glycerol. In some embodiments, sorbitol is not preferred because it can cause gastric distress when consumed by certain individuals. In some embodiments, the low-viscosity methylcellulose solution consists of water, methylcellulose and the polarity-reducing agent.

A method of preparing a low-viscosity methylcellulose solution in accordance with the present invention includes combining water, methylcellulose and a polarity-reducing agent. In preferred embodiments, the viscosity of the solution is about 430 centipoise (cP) or less. In preferred embodiments, the solution includes up to about 2% methylcellulose (i.e., more than 0% methylcellulose but no more than about 2% methylcellulose, e.g., from about 1% to about 2%). In some embodiments, the low-viscosity methylcellulose solution includes from about 0.5% to about 0.75% of a polarity-reducing agent. In some embodiments, the water and methylcellulose are combined first before the polarity-reducing agent is added. In some embodiments, the water is heated (e.g., to about 45° C.) before being combined with the methylcellulose and the polarity-reducing agent.

A method of preparing a reduced-fat fried low-moisture snack product in accordance with the present invention includes applying a low-viscosity methylcellulose solution to a surface of a low-moisture snack food to form a coated low-moisture snack food. In some embodiments, the low-moisture snack food has a moisture content from about 1% to about 10%. In some embodiments, the low-moisture snack food includes a rye chip, a corn chip and/or a component of a snack mix. In preferred embodiments, the low-viscosity methylcellulose solution is applied by dipping or by spraying (e.g., with a nozzle). Also preferably, a thin coating of the low-viscosity solution is formed on the surface of the low-moisture snack food. In some embodiments, the low-moisture snack food is dried to further reduce moisture before the low-viscosity methylcellulose solution is applied. The method of preparing the reduced-fat fried low-moisture snack product can further include a step of preparing the low-viscosity methylcellulose solution (e.g., as described above). In some embodiments, the method further includes frying (e.g., deep-frying) the coated low-moisture snack food.

A reduced-fat fried low-moisture snack product in accordance with the present invention has at least 20%, but more preferably at least about 40%, less fat than a conventional fried low-moisture snack product (i.e., a fried low-moisture snack product not prepared using a low-viscosity methylcellulose solution in accordance with the invention before frying). However, the reduced-fat fried low-moisture snack product maintains organoleptic characteristics of the conventional fried low-moisture snack product such as color and texture. In some embodiments, the reduced-fat fried low-moisture snack product has a fat content of from about 5% to about 20% by weight of the snack product, more preferably from about 8% to about 16%.

### EXAMPLES

Embodiments of the present invention will now be described with respect to the following non-limiting examples.

Each of the low-viscosity methylcellulose solutions in Table 1 (i.e., for Samples 3-14) were prepared by placing the water into a Thermomix® multi-purpose appliance. The temperature was set to 45° C. and the mixing speed was set to medium. The methylcellulose was gradually streamed into the water as the water was stirred. Mixing continued for another 5 minutes or until the methylcellulose was completely dissolved. The polarity-reducing agent was added and mixing continued for an additional minute. The resulting solution was allowed to cool to ambient temperature and rest overnight at ambient temperature.

TABLE 1

| | | Low-viscosity Methylcellulose Solution | | | | |
|---|---|---|---|---|---|---|
| Sam- | | | Polarity-reducing Agent | | | |
| ple | Rye | Methyl- | Sor- | Ery- | Gly- | |
| No. | Chips | cellulose | bitol | thritol | cerol | Water |
| 1 | 25 grams | N/A | N/A | N/A | N/A | N/A |
| (Control | | | | | | |
| A) | | | | | | |
| 2 | 25 grams | N/A | N/A | N/A | N/A | N/A |
| (Control | | | | | | |
| B) | | | | | | |
| 3 | 25 grams | 1% | 0.5% | — | — | 98.5% |
| 4 | 25 grams | 1% | — | 0.5% | — | 98.5% |
| 5 | 25 grams | 1% | — | — | 0.5% | 98.5% |
| 6 | 25 grams | 1% | 0.75% | — | — | 98.25% |
| 7 | 25 grams | 1% | — | 0.75% | — | 98.25% |
| 8 | 25 grams | 1% | — | — | 0.75% | 98.25% |
| 9 | 25 grams | 2% | 0.5% | — | — | 97.5% |
| 10 | 25 grams | 2% | — | 0.5% | — | 97.5% |
| 11 | 25 grams | 2% | — | — | 0.5% | 97.5% |
| 12 | 25 grams | 2% | 0.75% | — | — | 97.25% |
| 13 | 25 grams | 2% | — | 0.75% | — | 97.25% |
| 14 | 25 grams | 2% | — | — | 0.75% | 97.25% |

Rye chips (from Gardetto's® snack mix) were used as the low-moisture snack food. The rye chips had an initial moisture content of 5-8%. For each of Samples 3-14, a 25-gram batch of rye chips was dipped into the low-viscosity methylcellulose solution for 10 seconds then shook for 10 seconds. The 25-gram control batches of rye chips, Samples 1 and 2, were not treated with a low-viscosity methylcellulose solution. The uncoated (Samples 1 and 2) and coated (Samples 3-14) batches were deep fried in high oleic sunflower oil at 370° F. for 75 seconds.

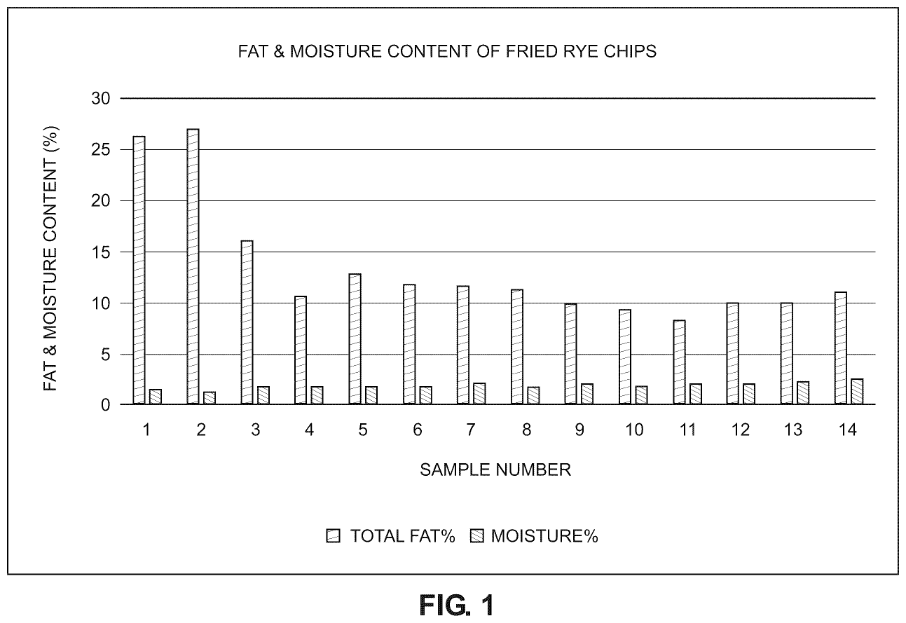

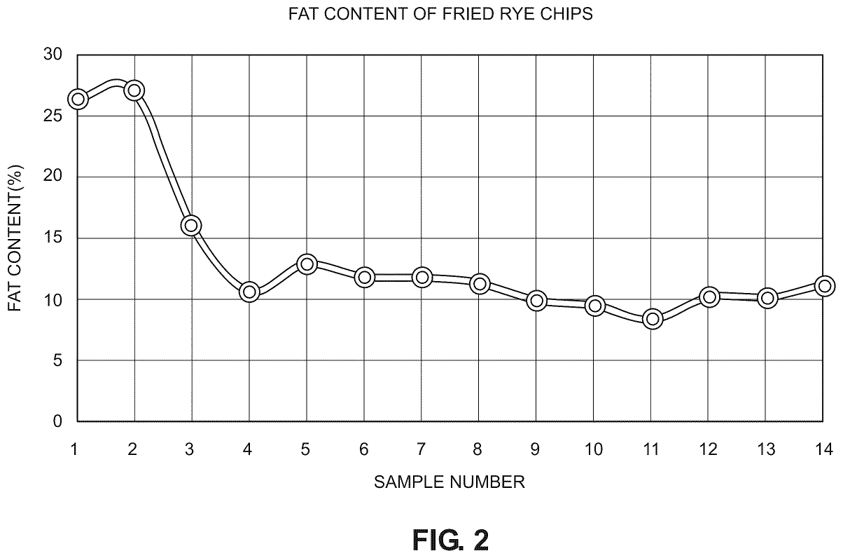

FIG. 1 and Table 2 disclose the moisture content and fat content of the example rye chips after frying. FIG. 2 illustrates the fat content for the fried samples. For Samples 3-14, Table 2 also indicates the moisture increase and fat uptake reduction compared to the average of the control samples after frying (i.e., compared to the average of the measurements for Samples 1 and 2). For example, Sample 4 had a fat content of 10.6% after frying while the average fat content of Samples 1 and 2 was 26.65% after frying. Thus, Sample 4 had a reduction of 60.23% compared to the average control fat content: ((26.65%−10.6%)÷26.65%)×100=60.23%. Further, Table 2 shows the color values (L*a*b*) determined for the samples after frying.

TABLE 2

| Sample | Moisture | Moisture | Fat | Fat | | | |
|---|---|---|---|---|---|---|---|
| No. | Content | Increase | Content | Reduction | L* | a* | b* |
| 1 (Control A) | 1.487% | N/A | 26.3% | N/A | 37.79 | 12.99 | 22.93 |
| 2 (Control B) | 1.328% | N/A | 27.0% | N/A | 38.89 | 13.5 | 23.64 |
| Control | 1.408% | N/A | 26.65% | N/A | 38.34 | 13.25 | 23.29 |
| Average | | | | | | | |
| 3 | 1.827% | 29.805% | 16.1% | 39.59% | 39.97 | 13.76 | 20.85 |
| 4 | 1.831% | 30.089% | 10.6% | 60.23% | 38.7 | 13.1 | 19.17 |
| 5 | 1.892% | 34.423% | 12.8% | 51.97% | 40.34 | 13.61 | 20.73 |
| 6 | 2.003% | 42.309% | 11.8% | 55.72% | 39.7 | 13.35 | 20.25 |
| 7 | 2.214% | 57.300% | 11.7% | 56.10% | 41.05 | 13.9 | 21.6 |
| 8 | 1.792% | 27.318% | 11.3% | 57.60% | 39.09 | 13.63 | 20.29 |
| 9 | 2.161% | 53.535% | 8.3% | 68.86% | 46.13 | 13.34 | 23.27 |
| 10 | 1.871% | 32.931% | 9.4% | 64.73% | 44.88 | 13 | 22.4 |
| 11 | 2.161% | 53.535% | 8.3% | 68.86% | 46.13 | 13.34 | 23.27 |
| 12 | 2.081% | 47.851% | 10.1% | 62.10% | 42.45 | 13.3 | 22.02 |
| 13 | 2.350% | 66.963% | 10.1% | 62.10% | 45.3 | 13.18 | 23.08 |
| 14 | 2.545% | 80.817% | 11.1% | 58.35% | 46.3 | 13.34 | 23.71 |

As shown by Table 2 and FIGS. 1 and 2, the samples treated with the low-viscosity methylcellulose solution in accordance with the present invention had a reduction in fat uptake of at least 20%, but more preferably at least about 40% (in particular, a reduction of between 39.59% and 68.86% as shown). The L*a*b* color measurements, and particularly the L* values, show that browning reactions still occurred in the samples treated with the low-viscosity methylcellulose solution, indicating that the fried snack products in accordance with the invention still received the organoleptic benefit of frying.

Table 3 below shows the viscosity of various methylcellulose solutions at three different times (T1, T2, T3) as well as the average of these viscosities. Viscosity was measured using a Brookfield DV-III Ultra Rheometer with a #2 spindle (10 RPM at 25 seconds).

TABLE 3

| | | Viscos- | Viscos- | Viscos- | Average |
|---|---|---|---|---|---|
| | Temper- | ity | ity | ity | Viscos- |
| | ature | at T1 | at T2 | at T3 | ity |
| Solution | (° F.) | (cP) | (cP) | (cP) | (cP) |
| 2% methylcellulose + | 72.4 | 504 | 512 | 516 | 510.67 |
| 0.5% glycerol | | | | | |
| 1% methylcellulose + | 72.3 | 36 | 36 | 36 | 36 |
| 0.5% sorbitol | | | | | |
| 2% methylcellulose + | 72.8 | 428 | 428 | 432 | 429.33 |
| 0.75% glycerol | | | | | |
| 2% methylcellulose | 72.6 | 516 | 512 | 508 | 512 |

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of preparing a reduced-fat fried low-moisture snack product, the method comprising
applying a low-viscosity methylcellulose solution to a surface of a low-moisture snack food to form a coated low-moisture snack food, wherein the low-viscosity methylcellulose solution includes water, methylcellulose and a polarity-reducing agent; and
frying the coated low-moisture snack food to form the reduced-fat fried low-moisture snack product.

2. The method of claim 1, wherein the low-viscosity methylcellulose solution has a viscosity of about 430 cP or less.

3. The method of claim 1, wherein the low-viscosity solution includes up to about 2% methylcellulose by weight of the solution.

4. The method of claim 1, wherein the low-viscosity solution includes from about 0.5% to about 0.75% polarity-reducing agent by weight of the solution.

5. The method of claim 1, wherein the polarity-reducing agent includes erythritol, glycerol or a combination thereof.

6. The method of claim 1, wherein the low-moisture snack food has a moisture content from about 1% to about 10% by weight of the low-moisture snack food.

7. The method of claim 1, wherein the reduced-fat fried low-moisture snack product has a fat content of from about 5% to about 20% by weight of the snack product.

8. The method of claim 1, wherein the low-moisture snack food includes a rye chip, a corn chip, a component of a snack mix or a combination thereof.

9. The method of claim 1, further comprising drying the low-moisture snack food before applying the low-viscosity methylcellulose solution.

10. A reduced-fat fried low-moisture snack product prepared by the method of claim 1.
